(19) United States
(12) Patent Application Publication
(10) Pub. No.: US 2026/0056034 A1
(43) Pub. Date: Feb. 26, 2026

(54) TRANSFORMERLESS DEMODULATION OF SYNCHRO-RESOLVER

(71) Applicant: Hamilton Sundstrand Corporation, Charlotte, NC (US)

(72) Inventor: John O'Neil, Litchfield, CT (US)

(21) Appl. No.: 18/813,636

(22) Filed: Aug. 23, 2024

(51) Int. Cl. G01D 5/20; G08C 19/46; H04L 25/02

(52) U.S. Cl. CPC G01D 5/2073; G08C 19/46; H04L 25/0272

(57) ABSTRACT

Apparatus and associated methods relate to a transformer-less way of demodulating signals generated by a synchro-resolver so as to determine a shaft angle of the synchro-resolver. A first differential output voltage between a first pair of the wye-configured secondary windings is used to generate a first output. A second differential output voltage between a second pair of the wye-configured secondary windings, different from the first pair, is used to generate a second output. The first and second outputs are combined to form a signal quadrature to the first output. The first output and the signal quadrature thereto are used to determine the shaft angle.

### BACKGROUND

Attitude sensors are used for aircraft navigation. For example, pitch, yaw, and roll are detected, often with redundancy, to provide feedback to pilots and to facilitate navigational control of the aircraft. Synchro-resolvers can be used for such navigational purposes. Synchro-resolvers (or synchros) are a type of transformer whose primary-to-secondary coupling can be varied by physically changing the relative orientation of these windings. The primary winding of the synchro-resolver is usually wound about a rotatable core or rotor and the secondary windings are wound about a fixed core or stator. The secondary windings typically include three wye-configured windings arranged at 120-degree intervals about the rotor. The primary winding is excited by an alternating current, which electromagnetically induces voltages in each of the three wye-configured secondary windings. The voltages induced in the secondary windings and indicative of an angle of the rotor relative to the stator.

In prior art synchro synchro-demodulators, a Scott-T transformer is typically used to convert the three-phase output signals of the synchro-resolver into two quadrature phase sinusoidal signals, from which a shaft angle can be determined. Scott-T transformers are relatively bulky (i.e., large and heavy) electrical components, however, making the synchro-demodulators similarly bulky.

### SUMMARY

Some embodiments relate to a method for generating a signal indicative of a shaft angle of a synchro-resolver. In the method, a first differential signal induced between a first output terminal and a second output terminal of a three-phase secondary winding of the synchro-resolver is convolved with a first sine wave having a period and a phase equal to a period and phase of the first differential signal, thereby generating a first convolution result. The magnitude of the first differential signal is then used as a measure of a sine of the shaft angle. A second differential signal induced between the first output terminal and a third output terminal of a three-phase secondary winding of the synchro-resolver is convolved with a first sine wave having a period and a phase equal to a period and phase of the first differential signal, thereby generating a first convolution result. A magnitude of the first differential signal is then determined based on the first convolution result. A measure of a cosine of the shaft angle is created based on a weighted sum of the measures of the magnitudes of the first and second differential signals. The shaft angle is then determined based on the measures of the sine and cosine of the shaft angle.

Some embodiments relate to a synchro-demodulator for generating a signal indicative of a shaft angle of a three-phase synchro-resolver. the synchro-demodulator includes a first analog-to-digital (A/D) converter that receives a first voltage differential between a first output terminal of first secondary windings of the three-phase synchronous resolver and a second output terminal of second secondary windings of the three-phase synchro-resolver. The first A/D converter is further configured to generate a first digitized sampling of the first voltage differential. The synchro-demodulator includes a second A/D converter that receives a second voltage differential between the first output terminal of first secondary windings of the three-phase synchronous resolver and a third output terminal of third secondary windings of the three-phase synchro-resolver. The second A/D converter is further configured to generate a second digitized sampling of the second voltage differential. The synchro-demodulator includes a processor configured to receive the first and second digitized samplings. The synchro-demodulator also includes computer readable memory containing instructions that, when executed by the processor cause the synchro-demodulator to: i) convolving a first differential signal induced between a first output terminal and a second output terminal of a three-phase secondary winding of the synchro-resolver with a first sine wave having a period and a phase equal to a period and phase of the first differential signal, thereby generating a first convolution result; ii) determine a magnitude of the first differential signal based on the first convolution result; iii) use the magnitude of the first differential signal as a measure of sine of the shaft angle; iv) convolving a second differential signal induced between the first output terminal and a third output terminal of a three-phase secondary winding of the synchro-resolver with a second sine wave having a period and a phase equal to a period and phase of the second differential signal, thereby generating a first convolution result; v) determine a magnitude of the first differential signal based on the second convolution result; vi) create a measure of a cosine of the shaft angle based on a weighted sum of the measures of the magnitudes of the first and second differential signals; and vii) determine the shaft angle based on the measures of the sine and cosine of the shaft angle.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a block diagram of an embodiment of an attitude sensing system used on an aircraft.

FIG. 2 is a graph of one of the three output signals provided by a three-phase synchro-resolver.

FIG. 3 is a graph depicting all three voltage envelopes corresponding to the three output signals provided by a three-phase synchro-resolver.

FIG. 4 is flowchart of a method for demodulating a three-phase synchro-resolver.

FIG. 5 is a flowchart of a method for normalizing the gain in the channels corresponding to each of the differential voltages V₃₁(t) and V₂₁(t).

FIG. 6 is a graph of gain error as a function of rotor angle θ.

### DETAILED DESCRIPTION

Apparatus and associated methods relate to a transformer-less way of demodulating signals generated by a synchro-resolver so as to determine a shaft angle of the synchro-resolver. A first differential output voltage between a first pair of the wye-configured secondary windings can be used to generate a first output. A second differential output voltage between a second pair of the wye-configured secondary windings, different from the first pair, can be used to generate a second output. The first and second outputs are combined to form a signal quadrature to the first output. The first output and the signal quadrature thereto are used to determine the shaft angle.

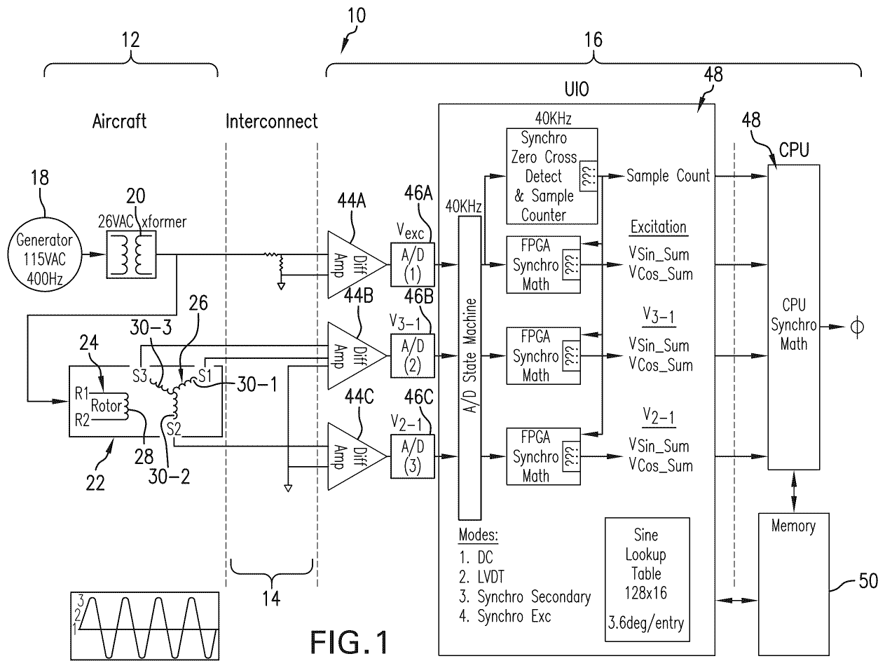

FIG. 1 is a block diagram of an embodiment of an attitude sensing system used on an aircraft. In FIG. 1, angular position system 10 includes aircraft hardware 12, interconnect 14, and demodulating system 16. Aircraft hardware 12 includes Alternating Current (AC) power generator 18, step-down transformer 20, and synchro-resolver 22. AC power generator 18 can be configured to generate AC power for various AC-powered systems used on an aircraft. Typically, AC power generator 18 generates AC power at a frequency of 400 Hz±20 Hz and an amplitude of 115 V. Step-down transformed 20 can be configured to receive the AC power generated by AC power generator 18 at terminals for primary windings and then generates a lower voltage signal at terminals of secondary windings. The voltage of the AC power output at the terminals of the secondary windings of step-down transformer 20 in accordance with a specification (e.g., within the limits specified) for AC excitation signal for synchro-resolver 22. Such an AC excitation signal is given by:

$${V}_{E X C} ( t ) = {V}_{1} sin ( ω t ) \qquad ( 1 )$$

where V₁ is the amplitude (typically about 26 VAC) and ω is equal to two-pi (2π) times the frequency f of the excitation signal, which is the same frequency as the 400 Hz AC power signal applied to the primary windings of step-down transformer 20.

Synchro-resolver 22 has rotor 24 and stator 26. Primary windings 28 of synchro-resolver 22 are wound about or located on rotor 24. The AC excitation signal V_{EXC}(t) can be provided across primary windings 28, thereby causing electrical current to flow within primary windings 28. Secondary windings 30-1, 30-2, and 30-3 of synchro-resolver 22 are connected with one another at a common node in a wye configuration. Secondary windings 30-1, 30-2, and 30-3 are oriented on or within stator 26 at 120 degrees of phase separation, one from another. Primary windings 28 and secondary windings 30-1, 30-2, and 30-3 are electromagnetically coupled to one another, thereby facilitating electrical currents to be induced in secondary windings 30-1, 30-2, and 30-3 in response to electrical currents conducted within primary windings 28. Because of the 120-degree phase separation between secondary windings 30-1, 30-2, and 30-3, electrical currents induced therein are indicative of orientation of rotor 24 with respect to stator 26.

Terminal voltages V₁(t), V₂(t), and V₃(t) at terminal ends of the wye-configurated secondary windings 30-1, 30-2, and 30-3 result from the electrical currents induced within secondary windings 30-1, 30-2, and 30-3, respectively. As such, terminal voltages V₁(t), V₂(t), and V₃(t) are similarly indicative of orientation of rotor 24 with respect to stator 26. Terminal voltages V₁(t), V₂(t), and V₃(t) can be measured with respect to voltage at the common node of the wye-configured secondary windings 30-1, 30-2, and 30-3 and then used to determine orientation of rotor 24 with respect to stator 26. In other embodiments, differential voltages V₁₃(t), V₃₂(t), and V₂₁(t) as measured between pairs of terminal ends can be used to determine orientation of rotor 24 with respect to stator 26. First, second, and third differential voltages V₁₃(t), V₃₂(t), and V₂₁(t) are voltage differences between the terminal ends of secondary windings 30-1 and 30-3, between the terminal ends of secondary windings 30-3, and 30-2, and between the terminal ends of secondary windings 30-2 and 30-1, respectively. Such differential voltages are given by:

$${V}_{13} ( t ) = {K}_{1} \cdot {V}_{1} sin ( θ ) sin ( ω t + {φ}_{13} ) \qquad ( 2 )$$

$${V}_{32} ( t ) = {K}_{2} \cdot {V}_{1} sin ( θ + 120 ° ) sin ( ω t + {φ}_{32} ) \qquad ( 3 )$$

$${V}_{21} ( t ) = {K}_{3} \cdot {V}_{1} sin ( θ + 240 ° ) sin ( ω t + {φ}_{21} ) \qquad ( 4 )$$

where K₁, K₂, and K₃ are the coupling coefficients between primary winding 28 and secondary windings 30-1, 30-2, and 30-3, respectively; φ₁₃, φ₃₂, and φ₂₁ are differences between the phase of the excitation signal V_{EXC}(t) and the phases of the first, second, and third differential voltages V₁₃(t), V₃₂(t), and V₂₁(t), respectively; and rotor angle θ is the angle of rotor 24 with respect to stator 26, which is the metric that is desired to be determined by synchro-demodulator 16.

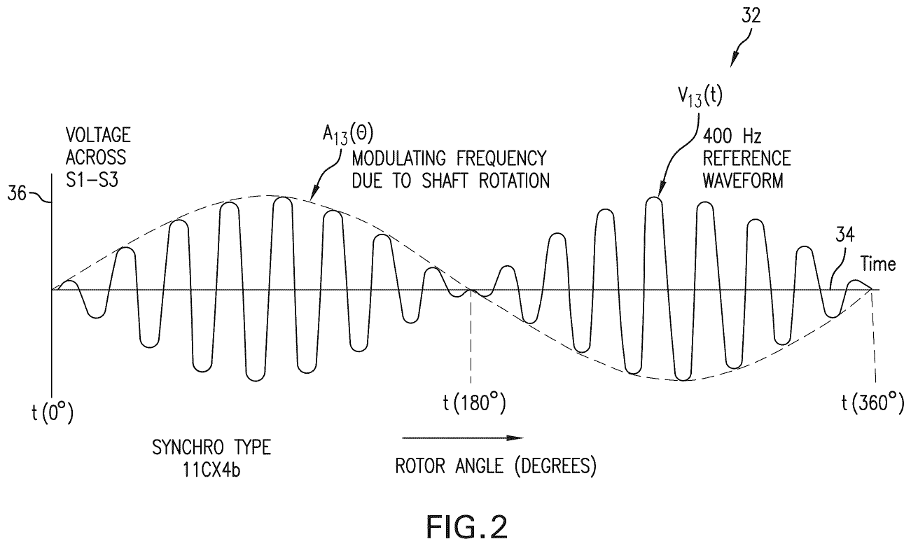

FIG. 2 is a graph of one of the three differential voltages V₁₃(t), V₃₂(t), and V₂₁(t) provided by three-phase synchro-resolver 22. In FIG. 2, graph 32 includes horizontal axis 34, vertical axis 36 and first differential voltage V₁₃(t) as expressed in equation (2) above. Horizontal axis 34 is indicative of time and vertical axis 36 is indicative of voltage. Horizontal axis 34 is scaled so as to depict first differential voltage V₁₃(t) as rotor 24 is rotated through one full cycle of rotation (i.e., through rotor angles θ between 0 and 360°) at a constant rate of rotation. Also shown in graph 32 is first voltage envelope A₁₃(θ). First voltage envelope A₁₃(θ) is the voltage envelope that defines the magnitude of first differential voltage V₁₃(t) as a function or rotor angle θ. Second and third differential voltages V₃₂(t) and V₂₁(t) similarly have voltage envelopes A₃₂(θ) and A₂₁(θ), respectively, which define the magnitude of such differential voltages:

$${A}_{13} = {K}_{1} \cdot {V}_{1} sin ( θ ) \qquad ( 5 )$$

$${A}_{32} = {K}_{2} \cdot {V}_{1} sin ( θ + 120 ° ) , and \qquad ( 6 )$$

$${A}_{21} = {K}_{3} \cdot {V}_{1} sin ( θ + 240 ° ) \qquad ( 7 )$$

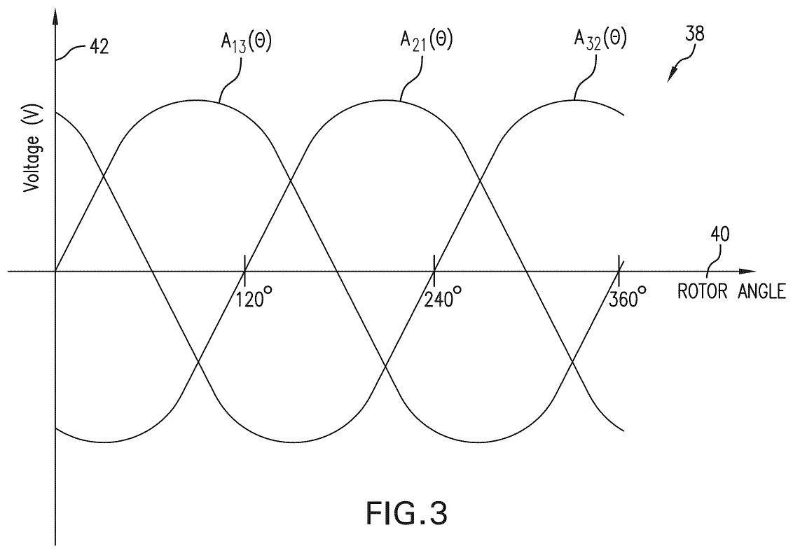

FIG. 3 is a graph depicting all three voltage envelopes A₁₃(θ), A₃₂(θ), and A₂₁(θ) as expressed in equations (5), (6), and (7), above. In FIG. 3, graph 38 includes horizontal axis 40, vertical axis 42 and voltage envelopes A₁₃(θ), A₃₂(θ), and A₂₁(θ). Horizontal axis 40 is indicative of rotor angle θ, and vertical axis 42 is indicative of voltage. As depicted in graph 38, each of voltage envelopes A₁₃(θ), A₃₂(θ), and A₂₁(θ) are 120° out of phase with one another. Each of the voltage envelopes A₁₃(θ), A₃₂(θ), and A₂₁(θ) are functions, which means that at any given rotor angle θ, each of voltage envelopes A₁₃(θ), A₃₂(θ), and A₂₁(θ) has a single value associated with that specific rotor angle θ. As each of voltage envelopes A₁₃(θ), A₃₂(θ), and A₂₁(θ) are sinusoids, their inverses are not functions. Thus, if any one of the voltage envelopes A₁₃(θ), A₃₂(θ), and A₂₁(θ) is known, then the rotor angle θ can only be determined to be one of two different values. If, however, any two of these three voltage envelopes A₁₃(θ), A₃₂(θ), and A₂₁(θ) can be determined, then the rotor angle θ can be uniquely determined therefrom.

Rotor angle θ is ultimately determined by taking the arctangent of a ratio of sine of rotor angle θ and the cosine of rotor angle θ:

$$θ = arc tan ( \frac{sin ( θ )}{cos ( θ )} ) . \qquad ( 8 )$$

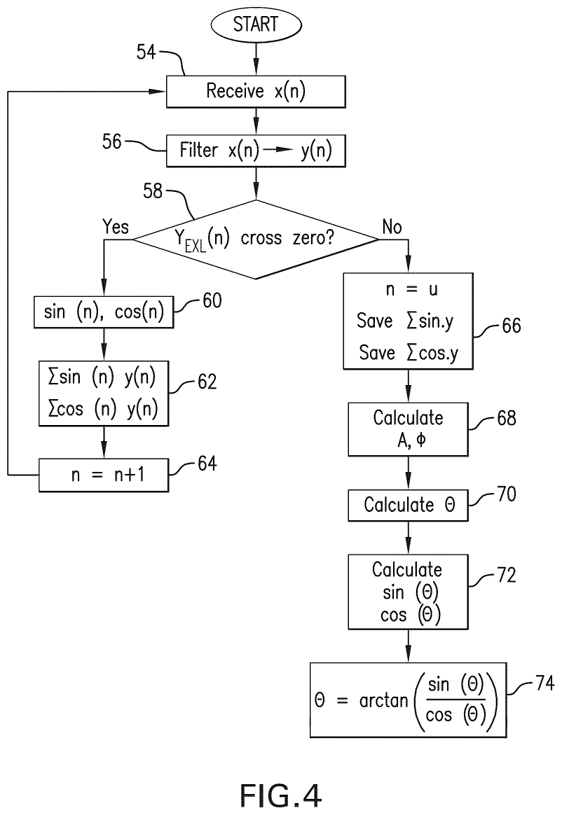

Before such an inverse hyperbolic function (i.e., the arctan function) can be used for determining rotor angle θ, both the sine and cosine of the rotor angle θ must be determined. An exemplary method for determining both the sine and the cosine of the rotor angle θ will be disclosed below with reference to FIG. 4.

Coupling coefficients K₁, K₂, and K₃, as shown in equations (5)-(7), are approximately equal to one another for typical synchro-resolvers, such as synchro-resolver 22, as are phase differences φ₁, φ₂, and φ₃. Thus, the magnitudes of first, second, and third differential voltages V₁₃(t), V₃₂(t), and V₂₁(t) are primarily, but not exclusively, determined by the angle θ is of rotor 24. To obtain the most precise determination of rotor angle θ, all coupling coefficients K₁, K₂, and K₃ and/or phase differences φ₁, φ₂, and φ₃ can also be determined. Simulations have shown, however, that errors in determining rotor angle θ that result from typical phase differences φ₁, φ₂, and φ₃ are small (e.g., an error of 1.2 arc-seconds for rotor angle θ results from a 4-degree phase difference between φ₁ and φ₂). Thus, correcting phase differences φ₁₃, φ₃₂, and φ₂₁ is not strictly necessary. Correcting differences in coupling coefficients K₁, K₂, and K₃ also is not strictly necessary.

Returning to FIG. 1, demodulating system 16 is configured to generate a signal indicative of a rotor angle θ based on at least two of the first, second, and/or third differential voltages V₁₃(t), V₃₂(t), and V₂₁(t) generated by synchro-resolver 22. Although only two of these three differential voltages V₁₃(t), V₃₂(t), and V₂₁(t) are needed to uniquely determine rotor angle θ, any two of these three differential voltages necessarily require for generation all three of the terminal voltages V₁(t), V₂(t), and V₃(t) at the terminals of the wye-configured secondary windings 30-1, 30-2, and 30-3. Demodulating system 16 receives terminal voltages V₁(t), V₂(t), and V₃(t) from aircraft hardware 12 vis interconnect 14. In some embodiments, one of terminal voltages V₁(t), V₂(t), and V₃(t) can be grounded.

Demodulating system 16 includes differential amplifiers 44A-44C, Analog-to-Digital (A/D) converters 46A-46C, and processor 48, which can include program code configured to perform a method for demodulating the signals generated by synchro-resolver 22. Differential amplifier 44A is configured to generate a buffered and amplified version of excitation signal V_{EXC}(t) received via interconnect 14. Differential amplifies 44B and 44C are configured to generate differential voltages V₃₁(t) and V₂₁(t), from terminal voltages V₁(t), V₂(t), and V₃(t) received via interconnect 14. In the depicted embodiment, terminal voltage V₁(t) is grounded. Differential voltage V₃₁(t) is simply the additive inverse of differential voltage V₁₃(t). A/D converter 46A receives the buffered and amplified version of excitation signal V_{EXC}(t), samples it, and converts it to a digital format. A/D converters 46B and 46C receive the differential voltages V₃₁(t) and V₂₁(t) generated by differential amplifiers 44B and 44C, respectively. A/D converters 46A-46C sample their respective analog signals at a frequency that is higher than the frequency f of the excitation signal V_{EXC}(t), typically much higher. For example, the sampling frequency of A/D converters 46A-46C can be 100 times or more than the 400 Hz frequency f of the excitation signal V_{EXC}(t). Processor 48 then determines rotor angle θ using such digitized samples of the excitation signal V_{EXC}(t) and the differential voltages V₃₁(t) and V₂₁(t) generated, as will be described in more detail below, with reference to FIG. 4.

In various embodiments, synchro-demodulator 16 can be realized using the elements illustrated in FIG. 1 or various other elements. For example, processor 48 can include any one or more of a microprocessor, a control circuit, a digital signal processor (DSP), an application specific integrated circuit (ASIC), a field-programmable gate array (FPGA), or other equivalent discrete or integrated logic circuitry. Various elements of synchro-demodulator 16 can be implemented in either hardware or software. For example, an FPGA can be configured to implement some elements in hardware and others in software. For software implemented elements, computer readable memory 50 can contain instructions that, when executed by processor 48, will cause synchro-demodulator 16 to perform operations pertaining to such elements.

Computer readable memory 50 can be configured to store information within synchro-demodulator 16 during operation. Computer readable memory 50, in some examples, is described as computer-readable storage media. In some examples, a computer-readable storage media can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, computer readable memory 50 is a temporary memory, meaning that a primary purpose of computer readable memory 50 is not long-term storage. Computer readable memory 50, in some examples, is described as volatile memory, meaning that computer readable memory 50 does not maintain stored contents when power to heat exchange system 30 is turned off. Examples of volatile memories can include random access memories (RAM), dynamic random-access memories (DRAM), static random-access memories (SRAM), and other forms of volatile memories. In some examples, computer readable memory 50 is used to store program instructions for execution by processor 48. Computer readable memory 50, in one example, is used by software or applications running on synchro-demodulator 16 (e.g., a software program implementing various operational functions pertaining to determining shaft angle using outputs of synchro-resolver 22) to temporarily store information during program execution, such as, for example, in data computer readable memory 50.

In some examples, computer readable memory 50 can also include one or more computer-readable storage media. Computer readable memory 50 can be configured to store larger amounts of information than volatile memory. Computer readable memory 50 can further be configured for long-term storage of information. In some examples, computer readable memory 50 includes non-volatile storage elements. Examples of such non-volatile storage elements can include magnetic hard discs, optical discs, flash memories, or forms of electrically programmable memories (EPROM) or electrically erasable and programmable (EEPROM) memories.

FIG. 4 is flow chart of one embodiment of a method for demodulating a three-phase synchro-resolver. Method 52 as depicted in FIG. 4 can be executed by processor 48, which is depicted in FIG. 3. Method 52 begins at step 54 where the processor 48 receives the next digitized sample x_{EXC}(n), x₃₁(n), and x₂₁(n) of the excitation signal V_{EXC}(t) and the differential voltages V₃₁(t) and V₂₁(t). Although this embodiment uses the differential voltages V₃₁(t) and V₂₁(t), any two of differential voltages V₁₃(t), V₃₂(t), and V₂₁(t) can be used to determine rotor angle θ. Method 52 then advances to step 56, where processor 48 performs a digital filtering operation to generate filtered values y_{EXC}(n), y₃₁(n), and y₂₁(n) of the digitized samples X_{EXC}(n), X₃₁(n), and x₂₁(n). Various types of digital filtering can be performed, such as for example, various finite response filtering and infinite response filtering as are known in the art. Then, at step 58 processor 48 determines whether the excitation signal V_{EXC}(t) has made a negative-to-positive zero crossing (i.e., whether y_{EXC}(n) has become positive after a previous negative value y_{EXC}(n−1)). Step 56 is used to determine at which sampling of the excitation signal V_{EXC}(t), has a last period of the excitation signal V_{EXC}(t) ended and a new period of the excitation signal V_{EXC}(t) begun.

If, at step 58, processor 48 determines that excitation signal V_{EXC}(t) has not crossed from a negative voltage to a positive voltage (i.e., a new period of the excitation signal V_{EXC}(t) has not begun and a last period of the excitation signal V_{EXC}(t) has not ended), then method 52 advances to step 60 where processor 48 synthesizes sine and cosine values of the phase of the excitation signal V_{EXC}(t) period at which the last samples were obtained. The phase of the excitation signal V_{EXC}(t) period is given by:

$$phase = 2 π \frac{n}{{n}_{max}} . \qquad ( 9 )$$

In some embodiments, processor 48 synthesizes the sine and cosine values of this phase using a lookup table. Such a lookup table can be used if the number of samples nₘₐₓ that are obtained in a period of the excitation signal V_{EXC}(t) is known. Method 52 advances from step 60 to step 62, where processor 48 multiplies each of the digitized and filtered samples y(n) by each of the sine and cosine values of the phase and then adds such a product to the running sums:

$${sum}_{s i n e} = {sum}_{s i n e} + y ( n ) sin ( phase ) , and \qquad ( 10 )$$

$${sum}_{c o s i n e} = {sum}_{c o s i n e} + y ( n ) cos ( phase ) , \qquad ( 11 )$$

Where such a sumₛᵢₙₑ and sum_{cosine} is accumulated for the digitized and filtered sampling for each of the excitation signal V_{EXC}(t) and the differential voltages V₃₁(t) and V₂₁(t) (i.e., for y_{EXC}(n), y₃₁(n), and y₂₁(n)).

This summing of the product of the digitized and filtered samples and the sine and cosine of the phase performs a convolution of the signals with each of the sine and cosine functions of the phase. All three of the excitation signal V_{EXC}(t) and the differential voltages V₃₁(t) and V₂₁(t) are approximately in phase with the sine function of the phase, differing in phase therefrom only by phase differences, such as phase differences φ_{E}XC, φ₃₂, and φ₂₁. Thus, one would expect the magnitudes of the sumₛᵢₙₑ values to be much larger than the magnitudes of the sum_{cosine} values. Method 52 advances from step 62 to step 64, where the sample index is advanced (i.e., n=n+1). Method 52 then returns to step 54, where the processor 48 receives the next digitized sample x_{EXC}(n), x₃₁(n), and x₂₁(n) of the excitation signal V_{EXC}(t) and the differential voltages V₃₁(t) and V₂₁(t).

If, however, at step 58, processor 48 determines that excitation signal V_{EXC}(t) has crossed from a negative voltage to a positive voltage (i.e., a new period of the excitation signal V_{EXC}(t) has begun and a last period of the excitation signal V_{EXC}(t) has ended), then method 52 advances to step 66 where processor 48 performs operations pertaining to the conclusion of the last period of the excitation signal V_{EXC}(t). At step 66, processor 48 saves the sums of the sine and cosine corresponding to each of the excitation signal V_{EXC}(t) and the differential voltages V₃₁(t) and V₂₁(t) (i.e., saves sumₛᵢₙₑ and sum_{cosine} for each of the excitation signal V_{EXC}(t) and the differential voltages V₃₁(t) and V₂₁(t)). In some embodiments, at step 66 processor can save the sample number n as the maximum number of samples nₘₐₓ obtained during the last period of the excitation signal V_{EXC}(t). At step 66, processor 48 also initializes the sample number n=0 within the period and the next sums of the sine and cosine corresponding to each of the excitation signal V_{EXC}(t) and the differential voltages V₃₁(t) and V₂₁(t) (i.e., sets summing accumulators to zero).

Method 52 advances from step 66 to step 68 where the stored values of sumₛᵢₙₑ and Sum_{cosine} are used to obtain amplitude and phase difference for each of the excitation signal V_{EXC}(t) and the differential voltages V₃₁(t) and V₂₁(t). Such amplitudes and phase differences are calculated as follows:

$$\vert A \vert = \frac{2}{{n}_{max}} \sqrt{{sum}_{s i n e}^{2} + {sum}_{c o s i n e}^{2}} , \qquad ( 12 )$$

$${A}_{m n} = \vert {A}_{m n} \vert sign ( {sum}_{s i n e} ) , and \qquad ( 13 )$$

$${φ}_{m n} = ( \frac{{sum}_{c o s i n e}}{{sum}_{s i n e}} ) . \qquad ( 14 )$$

Method 52 then advances from step 68 to step 70 where processor 48 calculates the sine and cosine of shaft angle θ. Such operations are performed as follows:

$$sin ( θ ) = \frac{{A}_{31}}{{K}_{1} \cdot {V}_{1}} and \qquad ( 15 )$$

$$cos ( θ ) = \frac{2}{\sqrt{3}} ( \frac{{A}_{31}}{2 {K}_{2} \cdot {V}_{1}} + \frac{{A}_{21}}{{K}_{1} \cdot {V}_{1}} ) , \qquad ( 16 )$$

where, in some embodiments, coupling coefficients K₁ and K₂ can be determined at a time of startup or at a time of calibration. In other embodiments, K₁ and K₂ are considered to be approximately equal to one another (K₁=K₂=K). Method 50 then advances from step 70 to step 72 where processor 48 calculates the shaft angle θ based on these sine and cosine values. Such operations are performed as follows:

$$θ = arc tan ( \frac{sin ( θ )}{cos ( θ )} ) . \qquad ( 17 )$$

In another embodiment, instead of convolving differential voltages V₃₁(t) and V₂₁(t) with both the sine and cosine waves which are synthesized in phase relation with the excitation signal V_{EXC}(t), sinusoidal waves can be synthesized in phase relation with each of differential voltages V₃₁(t) and V₂₁(t). Because such synthesized sinusoids are in phase relation with each of differential voltages V₃₁(t) and V₂₁(t), quadrature sinusoids (e.g., cosine waves) need not be synthesized, as convolution of such quadrature sinusoids with differential voltages V₃₁(t) and V₂₁(t) would yield zero values. The amplitudes A₃₁ and A₂₁ would be the direct result of such convolutions of phase related sinusoids (i.e., sinusoids in phase with differential voltages V₃₁(t) and V₂₁(t)).

To generate such phase-related sinusoidal waves, processor 48 would detect the zero-crossings of each of differential voltages V₃₁(t) and V₂₁(t). Such detected zero-crossings would be those corresponding to the negative-positive zero crossing of excitation signal V_{EXC}(t). Such corresponding zero-crossings typically would be the zero crossings that are most temporally close to one another. Zero crossings of differential voltages V₃₁(t) and V₂₁(t), which correspond to the negative-to-positive zero crossings of excitation signal V_{EXC}(t), can be either negative-to-positive type of zero crossing or positive-to-type of zero crossing. If the zero crossing of differential voltages V₃₁(t) and V₂₁(t) is such a positive-to-negative type of zero crossing, the amplitude of A₃₁ and/or A₂₁ would be made negative, as would be appropriate.

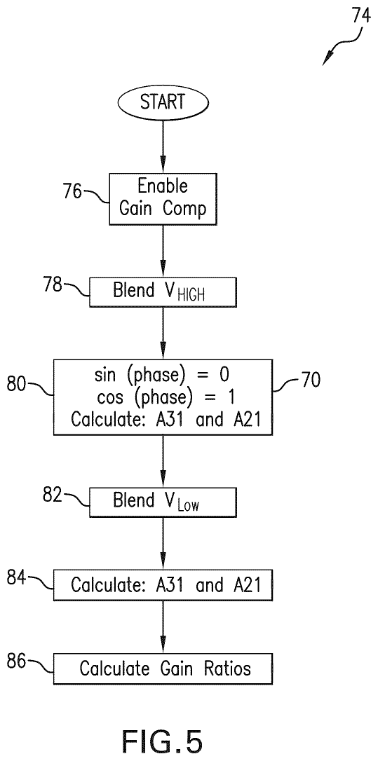

FIG. 5 is a flowchart of a method for normalizing the gain in the channels corresponding to each of the differential voltages V₃₁(t) and V₂₁(t). In FIG. 5 method 74 begins at step 76 where processor 48 enables gain compensation. Method 74 advances to step 78 where a first DC voltage V_{high} is blended into the differential voltages V₃₁(t) and V₂₁(t):

$${V}_{3 {1}_{-} BIT ( h i g h )} = {k V}_{31} + ( 1 - k ) {V}_{h i g h} \qquad ( 18 )$$

$${V}_{2 {1}_{-} BIT ( h i g h )} = {k V}_{21} + ( 1 - k ) {V}_{h i g h} \qquad ( 19 )$$

Method 74 then advances to step 80, where processor sets sin(phase)=0 and cos(phase)=1 and determines the amplitudes A₃₁ and A₂₁ as explained above. By setting the sin(phase)=0, the sumₛᵢₙₑ will accumulate to zero over a period of the excitation signal, and by setting the cos(phase)=1, the kV₃₁ and kV₂₁ portions of the waveforms will integrate to zero, as these portions are AC portions, while the sum_{cosine} will be indicative of the response to the V_{high} signal blended into the V₃₁ and V₂₁ channels. Method 74 then advances to step 82 where a second DC voltage V_{low} is blended into the differential voltages V₃₁(t) and V₂₁(t):

$${V}_{3 {1}_{-} BIT ( l o w )} = {k V}_{31} + ( 1 - k ) {V}_{l o w} \qquad ( 20 )$$

$${V}_{2 {1}_{-} BIT ( l o w )} = {k V}_{21} + ( 1 - k ) {V}_{l o w} \qquad ( 21 )$$

where k is a fraction 0<k<1. Method 74 then advances to step 84, where processor retains sin(phase)=0 and cos(phase)=1 and determines the amplitudes A₃₁ and A₂₁ as explained above. By setting the sin(phase)=0, the sumₛᵢₙₑ will accumulate to zero over a period of the excitation signal, and by setting the cos(phase)=1, the sum_{cosine} will be indicative of the response to the V_{high} signal blended into the V₃₁ and V₂₁ channels.

Method 74 advances to step 86 where processor 48 calculates a ratio of the gains of the two channels based upon the above four responses as indicated in equations (18)-(22) can be used to normalize the response of each of these two data paths. The ratio of the gains of these two data paths is given by:

$$\frac{{A}_{31}}{{A}_{21}} = \frac{{V}_{3 {1}_{-} BIT ( h i g h )} - {V}_{3 {1}_{-} BIT ( l o w )}}{{V}_{{21}_{-} BIT ( h i g h )} - {V}_{{21}_{-} BIT ( l o w )}} \qquad ( 22 )$$

Method 74 then advances to step 90, where processor 48 normalizes the gains of the two channels based upon the ratio obtained in equation (22).

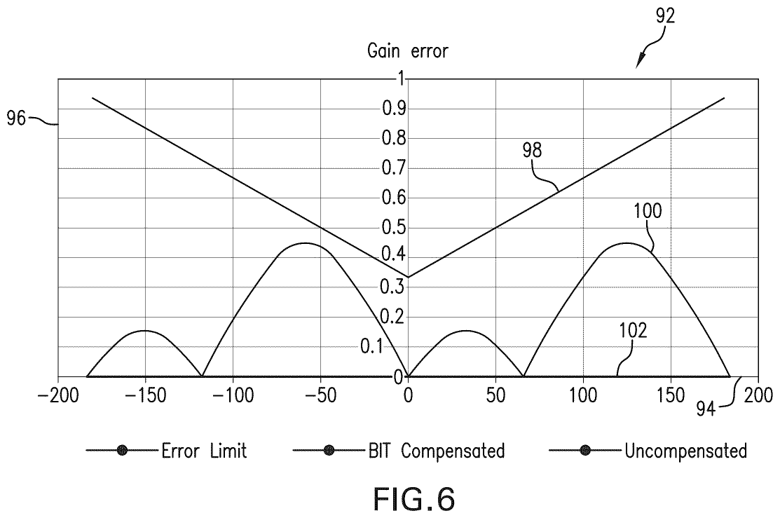

FIG. 6 is a graph of gain error as a function of rotor angle θ. In FIG. 6 graph 92 includes horizontal axis 94, vertical axis 96, specified gain error limit 98, uncompensated gain error 100 and compensated gain error 102. Horizontal axis 94 is indicative of rotor angle θ. Vertical axis 96 is indicative of gain error. Specified gain error limit 98 indicates a maximum gain error that demodulating system 16 (depicted in FIG. 1) can tolerate and still be able to determine rotor angle θ within a predetermined specification. Uncompensated gain error 100 indicates the gain error of demodulating system 16, which has not compensated for different gains of the V₃₁ and V₂₁ channels. Compensated gain error 102 indicates the gain error of demodulating system 16, which has compensated for different gains of the V₃₁ and V₂₁ channels.

### Discussion of Possible Embodiments

The following are non-exclusive descriptions of possible embodiments of the present invention.

Some embodiments relate to a method for generating a signal indicative of a shaft angle of a synchro-resolver. In the method, a first differential signal induced between a first output terminal and a second output terminal of a three-phase secondary winding of the synchro-resolver is convolved with a first sine wave having a period and a phase equal to a period and phase of the first differential signal, thereby generating a first convolution result. The magnitude of the first differential signal is then used as a measure of a sine of the shaft angle. A second differential signal induced between the first output terminal and a third output terminal of a three-phase secondary winding of the synchro-resolver is convolved with a first sine wave having a period and a phase equal to a period and phase of the first differential signal, thereby generating a first convolution result. A magnitude of the first differential signal is then determined based on the first convolution result. A measure of a cosine of the shaft angle is created based on a weighted sum of the measures of the magnitudes of the first and second differential signals. The shaft angle is then determined based on the measures of the sine and cosine of the shaft angle.

The method of the preceding paragraph can optionally include, additionally and/or alternatively, any one or more of the following features, configurations, and/or additional components:

A further embodiment of the foregoing method can further include providing the excitation signal to primary windings of the synchro-resolver.

A further embodiment of any of the foregoing methods, wherein determining the magnitude of the first differential signal induced between the first output terminal and the second output terminal of the three-phase secondary winding of the synchro-resolver can include: i) determining a zero-crossing of the first differential signal; ii) synthesizing a sine wave based on zero-crossing of the first differential signal, the sine wave having a period and a phase equal to a period and phase of the first differential signal; and iii) convolving the synthesized sine wave with the first differential signal induced between the first output terminal and the second output terminal of the three-phase secondary winding of the synchro-resolver, thereby determining a magnitude the first differential signal.

A further embodiment of any of the foregoing methods, wherein determining the magnitude of the second differential signal induced the first output terminal and the third output terminal of the three-phase secondary winding of the synchro-resolver can include: i) determining a zero-crossing of the second differential signal; ii) synthesizing a sine wave based on zero-crossing of the second differential signal, the sine wave having a period and a phase equal to a period and phase of the second differential signal; and iii) convolving the synthesized sine wave with the second differential signal induced between the first output terminal and the third output terminal of the three-phase secondary winding of the synchro-resolver, thereby determining a magnitude the second differential signal.

A further embodiment of any of the foregoing methods, wherein creating a measure of a cosine of the shaft angle based on a weighted sum of the measures of the magnitudes of the first and second differential signals can include weighting the magnitude of the first differential signal half as much as the magnitude of the second differential signal.

A further embodiment of any of the foregoing methods, wherein determining the shaft angle based on the measures of the sine and cosine of the shaft angle can further include taking a ratio of the measures of the sine and cosine of the shaft angle.

A further embodiment of any of the foregoing methods, wherein determining the shaft angle based on the measures of the sine and cosine of the shaft angle can further include taking the arctangent of the ratio of the measures of the sine and cosine of the shaft angle.

A further embodiment of any of the foregoing methods, wherein the measure of the shaft angle can be determined for each period of the excitation signal.

A further embodiment of any of the foregoing methods can further include normalizing magnitudes of the first and second differential signals based on first and second DC voltages blended into each of the first and second differential voltages.

A further embodiment of any of the foregoing methods, wherein the magnitudes of the first and second differential signals can be normalized by: i) setting the synthesized cosine signal to unity; ii) setting the synthesized sine signal to zero; iii) determining magnitude of the first and second differential signals for each of the first and second DC voltages blended thereinto; iv) determining gain of the first differential signal based on a difference in the magnitudes of the first differential signal for each of the blended DC voltages; and v) determining gain of the second differential signal based on a difference in the magnitudes of the second differential signal for each of the blended DC voltages.

Some embodiments relate to a synchro-demodulator for generating a signal indicative of a shaft angle of a three-phase synchro-resolver. the synchro-demodulator includes a first analog-to-digital (A/D) converter that receives a first voltage differential between a first output terminal of first secondary windings of the three-phase synchronous resolver and a second output terminal of second secondary windings of the three-phase synchro-resolver. The first A/D converter is further configured to generate a first digitized sampling of the first voltage differential. The synchro-demodulator includes a second A/D converter that receives a second voltage differential between the first output terminal of first secondary windings of the three-phase synchronous resolver and a third output terminal of third secondary windings of the three-phase synchro-resolver. The second A/D converter is further configured to generate a second digitized sampling of the second voltage differential. The synchro-demodulator includes a processor configured to receive the first and second digitized samplings. The synchro-demodulator also includes computer readable memory containing instructions that, when executed by the processor cause the synchro-demodulator to: i) convolving a first differential signal induced between a first output terminal and a second output terminal of a three-phase secondary winding of the synchro-resolver with a first sine wave having a period and a phase equal to a period and phase of the first differential signal, thereby generating a first convolution result; ii) determine a magnitude of the first differential signal based on the first convolution result; iii) use the magnitude of the first differential signal as a measure of sine of the shaft angle; iv) convolving a second differential signal induced between the first output terminal and a third output terminal of a three-phase secondary winding of the synchro-resolver with a second sine wave having a period and a phase equal to a period and phase of the second differential signal, thereby generating a first convolution result; v) determine a magnitude of the first differential signal based on the second convolution result; vi) create a measure of a cosine of the shaft angle based on a weighted sum of the measures of the magnitudes of the first and second differential signals; and vii) determine the shaft angle based on the measures of the sine and cosine of the shaft angle.

The synchro-demodulator of the preceding paragraph can optionally include, additionally and/or alternatively, any one or more of the following features, configurations, and/or additional components:

A further embodiment of the foregoing synchro-demodulator can further include a third A/D converter that receives a voltage signal of an excitation signal provided to primary windings of the synchro-resolver, the third A/D converter further configured to generate a third digitized sampling of the excitation signal.

A further embodiment of any of the foregoing synchro-demodulators, wherein determining the magnitude of the first differential signal induced between the first output terminal and the second output terminal of the three-phase secondary winding of the synchro-resolver can include: i) determining a zero-crossing of the first differential signal; ii) synthesizing a sine wave based on zero-crossing of the first differential signal, the sine wave having a period and a phase equal to a period and phase of the first differential signal; and iii) convolving the synthesized sine wave with the first differential signal induced between the first output terminal and the second output terminal of the three-phase secondary winding of the synchro-resolver, thereby determining a magnitude the first differential signal.

A further embodiment of any of the foregoing synchro-demodulators, wherein determining the magnitude of the second differential signal induced the first output terminal and the third output terminal of the three-phase secondary winding of the synchro-resolver can include: i) determining a zero-crossing of the second differential signal; ii) synthesizing a sine wave based on zero-crossing of the second differential signal, the sine wave having a period and a phase equal to a period and phase of the second differential signal; and iii) convolving the synthesized sine wave with the second differential signal induced between the first output terminal and the third output terminal of the three-phase secondary winding of the synchro-resolver, thereby determining a magnitude the second differential signal.

A further embodiment of any of the foregoing synchro-demodulators, wherein creating a measure of a cosine of the shaft angle based on a weighted sum of the measures of the magnitudes of the first and second differential signals can include weighting the magnitude of the first differential signal half as much as the magnitude of the second differential signal.

A further embodiment of any of the foregoing synchro-demodulators, wherein determining the shaft angle based on the magnitude of the first and second differential signals further can include taking a ratio of the measures of the sine and cosine of the shaft angle.

A further embodiment of any of the foregoing synchro-demodulators, wherein determining the shaft angle based on the magnitude of the first and second differential signals further can include taking the arctangent of the ratio of the measures of the sine and cosine of the shaft angle.

A further embodiment of any of the foregoing synchro-demodulators, wherein the measure of the shaft angle can be determined for each period of the excitation signal.

A further embodiment of any of the foregoing synchro-demodulators, wherein the computer readable memory can contain further instructions that, when executed by the processor cause the synchro-demodulator to normalize magnitudes of the first and second differential signals based on first and second DC voltages blended into each of the first and second differential voltages.

A further embodiment of any of the foregoing synchro-demodulators, wherein the magnitudes of the first and second differential signals are normalized by: i) setting the synthesized cosine signal to unity; ii) setting the synthesized sine signal to zero; iii) determining magnitude of the first and second differential signals for each of the first and second DC voltages blended thereinto; iv) determining gain of the first differential signal based on a difference in the magnitudes of the first differential signal for each of the blended DC voltages; and v) determining gain of the second differential signal based on a difference in the magnitudes of the second differential signal for each of the blended DC voltages.

It will be recognized that the invention is not limited to the implementations so described but can be practiced with modification and alteration without departing from the scope of the appended claims. For example, the above implementations may include specific combinations of features. However, the above implementations are not limited in this regard, and, in various implementations, the above implementations may include the undertaking only a subset of such features, undertaking a different order of such features, undertaking a different combination of such features, and/or undertaking additional features than those features explicitly listed. The scope of the invention should, therefore, be determined with reference to the appended claims, along with the full scope of equivalents to which such claims are entitled.

1. A method for generating a signal indicative of a shaft angle of a synchro-resolver, the method comprising:
convolving a first differential signal induced between a first output terminal and a second output terminal of a three-phase secondary winding of the synchro-resolver with a first sine wave having a period and a phase equal to a period and phase of the first differential signal, thereby generating a first convolution result;
determining a magnitude of the first differential signal based on the first convolution result;
using the magnitude of the first differential signal as a measure of a sine of the shaft angle;
convolving a second differential signal induced between the first output terminal and a third output terminal of a three-phase secondary winding of the synchro-resolver with a second sine wave having a period and a phase equal to a period and phase of the second differential signal, thereby generating a second convolution result;
determining a magnitude of the second differential signal based on the second convolution result;
creating a measure of a cosine of the shaft angle based on a weighted sum of the measures of the magnitudes of the first and second differential signals; and
determining the shaft angle based on the measures of the sine and cosine of the shaft angle.

2. The method of claim 1, further comprising:
providing a sinusoidal excitation signal to primary windings of the synchro-resolver.

3. The method of claim 1, wherein determining the magnitude of the first differential signal induced between the first output terminal and the second output terminal of the three-phase secondary winding of the synchro-resolver includes:
determining a zero-crossing of the first differential signal;
synthesizing a sine wave based on zero-crossing of the first differential signal, the sine wave having a period and a phase equal to a period and phase of the first differential signal; and
convolving the synthesized sine wave with the first differential signal induced between the first output terminal and the second output terminal of the three-phase secondary winding of the synchro-resolver, thereby determining a magnitude the first differential signal.

4. The method of claim 1, wherein determining the magnitude of the second differential signal induced the first output terminal and the third output terminal of the three-phase secondary winding of the synchro-resolver includes:
determining a zero-crossing of the second differential signal;
synthesizing a sine wave based on the zero-crossing of the second differential signal, the sine wave having a period and a phase equal to a period and phase of the second differential signal; and
convolving the synthesized sine wave with the second differential signal induced between the first output terminal and the third output terminal of the three-phase secondary winding of the synchro-resolver, thereby determining a magnitude the second differential signal.

5. The method of claim 1, wherein creating a measure of a cosine of the shaft angle based on a weighted sum of the measures of the magnitudes of the first and second differential signals comprises:
weighting the magnitude of the first differential signal half as much as the magnitude of the second differential signal.

6. The method of claim 1, wherein determining the shaft angle based on the measures of the sine and cosine of the shaft angle further comprises:
taking a ratio of the measures of the sine and cosine of the shaft angle.

7. The method of claim 6, wherein determining the shaft angle based on the measures of the sine and cosine of the shaft angle further comprises:
taking the arctangent of the ratio of the measures of the sine and cosine of the shaft angle.

8. The method of claim 2, wherein the measure of the shaft angle is determined for each period of the excitation signal.

9. The method of claim 1, further comprising:
normalizing magnitudes of the first and second differential signals based on first and second DC voltages blended into each of the first and second differential voltages.

10. The method of claim 9, wherein the magnitudes of the first and second differential signals are normalized by:
setting the synthesized cosine signal to unity;
setting the synthesized sine signal to zero;
determining magnitude of the first and second differential signals for each of the first and second DC voltages blended thereinto;
determining gain of the first differential signal based on a difference in the magnitudes of the first differential signal for each of the blended DC voltages; and
determining gain of the second differential signal based on a difference in the magnitudes of the second differential signal for each of the blended DC voltages.

11. A synchro-demodulator for generating a signal indicative of a shaft angle of a three-phase synchro-resolver, the synchro-demodulator comprising:
a first analog-to-digital (A/D) converter that receives a first voltage differential between a first output terminal of first secondary windings of the three-phase synchronous resolver and a second output terminal of second secondary windings of the three-phase synchro-resolver, the first A/D converter further configured to generate a first digitized sampling of the first voltage differential;
a second A/D converter that receives a second voltage differential between the first output terminal of first secondary windings of the three-phase synchronous resolver and a third output terminal of third secondary windings of the three-phase synchro-resolver, the second A/D converter further configured to generate a second digitized sampling of the second voltage differential;
a processor configured to receive the first and second digitized samplings; and
computer readable memory containing instructions that, when executed by the processor cause the synchro-demodulator to:
convolve a first differential signal induced between a first output terminal and a second output terminal of a three-phase secondary winding of the synchro-resolver with a first sine wave having a period and a phase equal to a period and phase of the first differential signal, thereby generating a first convolution result;
determine a magnitude of the first differential signal based on the first convolution result;
use the magnitude of the first differential signal as a measure of a sine of the shaft angle;
convolve a second differential signal induced between the first output terminal and a third output terminal of a three-phase secondary winding of the synchro-resolver with a second sine wave having a period and a phase equal to a period and phase of the second differential signal, thereby generating a second convolution result;
determine a magnitude of the second differential signal based on the second convolution result;
create a measure of a cosine of the shaft angle based on a weighted sum of the measures of the magnitudes of the first and second differential signals; and
determine the shaft angle based on the measures of the sine and cosine of the shaft angle.

12. The synchro-demodulator of claim 11, further comprising:
a third A/D converter that receives a voltage signal of an excitation signal provided to primary windings of the synchro-resolver, the third A/D converter further configured to generate a third digitized sampling of the excitation signal.

13. The synchro-demodulator of claim 1, wherein determining the magnitude of the first differential signal induced between the first output terminal and the second output terminal of the three-phase secondary winding of the synchro-resolver includes:
determining a zero-crossing of the first differential signal;
synthesizing a sine wave based on zero-crossing of the first differential signal, the sine wave having a period and a phase equal to a period and phase of the first differential signal; and
convolving the synthesized sine wave with the first differential signal induced between the first output terminal and the second output terminal of the three-phase secondary winding of the synchro-resolver, thereby determining a magnitude the first differential signal.

14. The synchro-demodulator of claim 13, wherein determining the magnitude of the second differential signal induced the first output terminal and the third output terminal of the three-phase secondary winding of the synchro-resolver includes:
determining a zero-crossing of the second differential signal;
synthesizing a sine wave based on zero-crossing of the second differential signal, the sine wave having a period and a phase equal to a period and phase of the second differential signal; and
convolving the synthesized sine wave with the second differential signal induced between the first output terminal and the third output terminal of the three-phase secondary winding of the synchro-resolver, thereby determining a magnitude the second differential signal.

15. The synchro-demodulator of claim 11, wherein creating a measure of a cosine of the shaft angle based on the weighted sum of the measures of the magnitudes of the first and second differential signals comprises:
weighting the magnitude of the first differential signal half as much as the magnitude of the second differential signal.

16. The synchro-demodulator of claim 11, wherein determining the shaft angle based on the measures of the sine and cosine of the shaft angle further comprises:
taking a ratio of the measures of the sine and cosine of the shaft angle.

17. The synchro-demodulator of claim 16, wherein determining the shaft angle based on the measures of the sine and cosine of the shaft angle further comprises:
taking the arctangent of the measures of the sine and cosine of the shaft angle.

18. The synchro-demodulator of claim 12, wherein the measure of the shaft angle is determined for each period of the excitation signal.

19. The synchro-demodulator of claim 11, wherein the computer readable memory contains further instructions that, when executed by the processor cause the synchro-demodulator to:
normalize magnitudes of the first and second differential signals based on first and second DC voltages blended into each of the first and second differential voltages.

20. The synchro-demodulator of claim 19, wherein the magnitudes of the first and second differential signals are normalized by:
setting the synthesized cosine signal to unity;
setting the synthesized sine signal to zero;
determining magnitude of the first and second differential signals for each of the first and second DC voltages blended thereinto;
determining gain of the first differential signal based on a difference in the magnitudes of the first differential signal for each of the blended DC voltages; and
determining gain of the second differential signal based on a difference in the magnitudes of the second differential signal for each of the blended DC voltages.
